(19) United States
(12) Patent Application Publication
(10) Pub. No.: US 2025/0242281 A1
(43) Pub. Date: Jul. 31, 2025

(54) FILTER, FILTER ELEMENT, HANDLE FOR REMOVING A FILTER ELEMENT, AND METHOD FOR DISASSEMBLY

(71) Applicant: MANN+HUMMEL GmbH, Ludwigsburg (DE)

(72) Inventors: Frank PFLÜGER, Sachsenheim (DE); Christian THALMANN, Speyer (DE); Jonas EBLE, Erlenbach (DE); Gina DA SILVA COSTA, Ludwigsburg (DE); Mischa WINTER, Brühl (DE)

(21) Appl. No.: 19/085,252

(22) Filed: Mar. 20, 2025

Related U.S. Application Data
(63) Continuation of application No. PCT/EP2023/077537, filed on Oct. 5, 2023.

(30) Foreign Application Priority Data
Oct. 7, 2022 (DE) 102022125986.2

(51) Int. Cl. B01D 27/08

(52) U.S. Cl. CPC B01D 27/08; B01D 2201/24; B01D 2201/4084

(57) ABSTRACT

A filter with a filter housing for an exchangeable filter element Includes a filter element latching action between filter housing and filter element that axially secures the filter element in the filter housing with radially movable latching members. A handle to pull the filter element from the housing includes a handle latching action between handle and filter element that holds the filter element with radially moveable latching fingers. Actuation surfaces between handle and filter element release the filter element latching action. Pushing the handle onto the filter element locks the handle latching action by the latching fingers while the actuation surfaces moving the latching members radially release the filter element latching action. For disassembly, the handle is pushed onto the filter element and the actuation surfaces release the latching members of the filter element latching action, and the filter element is pulled out by the handle.

### CROSS-REFERENCE TO RELATED APPLICATIONS

This application is a continuation application of international application No. PCT/EP2023/077537 having an international filing date of Oct. 5, 2023, and designating the United States, the international application claiming a priority date of Oct. 7, 2022, based on German patent application No. 10 2022 125 986.2, the entire contents of the aforesaid international application and the aforesaid German patent application being incorporated herein by reference.

### BACKGROUND

The invention concerns a filter with a filter housing, a filter element, and a handle for removing the filter element from the filter housing. The invention concerns furthermore a method for disassembly of the filter.

A filter with a filter housing for a filter element is disclosed in EP 3 263 202 A1. Furthermore, WO 2022/076248 A1 discloses a filter with a filter head and a filter element that is connectable in a detachable manner to the filter head.

In relation to this, it is an object of the invention to provide a filter with a filter housing for a filter element that is arranged securely fixed in the filter housing in the mounted state but is still easily removed.

### SUMMARY

This object is solved by a filter according to the invention, the filter comprising:
an exchangeable filter element;
a filter housing for receiving the filter element, wherein between filter housing and filter element a filter element latching action is provided, which holds the filter element in the mounted state in the filter housing so as to be secured against an axial pulling-out action, wherein the filter element latching action comprises a latching member which is radially movable at least in sections; and
a handle for axially pulling out the filter element from the filter housing, wherein between handle and filter element a handle latching action for holding the filter element and an actuation surface for releasing the filter element latching action are provided, wherein the handle latching action comprises a latching finger which is radially moveable at least in sections, wherein, by pushing the handle onto the filter element, the handle latching action is lockable by the latching finger and the filter element latching action is releasable due to the at least partial movement of the latching member caused by the actuation surface.

This object is further solved by a method according to the invention for disassembly of a filter according to the invention, the method comprising:
pushing the handle onto the filter element, wherein the handle latches at the filter element and at least one actuation surface releases the latching action of at least one latching member so that the handle latching action locks and the filter element latching action is released; and
pulling out the filter element by the handle from the filter housing.

Furthermore, the object is solved by a filter element for arrangement in the filter and a handle for removing the filter element from the filter. Further embodiments are disclosed in the following description and accompanying drawings.

According to the invention, a filter comprising a filter housing, a handle, and a filter element is provided. In the mounted state, the filter element is held axially secured in the filter housing by a filter element latching action with at least one latching member. The latching member is radially movable at least in sections. The handle may be connected by a handle latching action comprising at least one latching finger to the filter element. For this purpose, the latching finger is radially movable at least in sections. The handle comprises at least one actuation surface for release of the filter element latching action. The actuation surface actuates a displacement surface of the filter element latching action and releases in this way at least indirectly the filter element latching action.

According to the invention, it is thus possible to connect the handle to the filter element and also to release the filter element from its latching action at the filter housing by a single movement, namely pushing the handle onto the filter element. This facilitates the removal of the filter element which is securely fixed in normal operation. Since the handle is attached to the filter element only for disassembly of the filter, no space must be provided for the handle in the installed position so that the installation space that is available is optimally utilized. Furthermore, handle, filter element, and filter housing provide a lock-and-key system which prevents the use of wrong components in the service situation.

The latching member and/or the latching finger may extend/extends at least in sections, for example completely, in axial direction. The latching member and/or the latching finger may be formed of sheet metal and/or plastic material, for example entirely of plastic material. The latching finger may be L-shaped.

The filter element comprises a filter medium that surrounds a longitudinal axis in an annular shape. The filter medium may be folded in a star shape, for example, or wound. The filter medium may be round or oval in cross section.

The handle may be of a multi-part configuration. For example, the handle latching action and the actuation surface may be embodied at two different components. The handle however may be of a one-piece configuration.

In an alternative embodiment, the handle is of a multi-part configuration and comprises no actuation surface for unlatching the latching devices at the filter housing. The handle serves in this alternative embodiment only for removal of the filter element from the filter housing. By means of a separately configured actuation device, the filter insert may be released from the housing in that latching members are moved by the separately configured actuation device and release the filter element.

Directional specifications such as, for example, axial or radial, relate to the longitudinal axis of the filter, for example of the filter element, if nothing to the contrary is mentioned.

The filter medium may be stabilized radially inwardly by a support body, for example in the form of a support pipe. Alternatively or additionally, the filter medium may be stabilized externally by a cage. For outward stabilization, for example of the wound filter medium, a thread coil may be attached to the filter element.

The filter element may comprise an end disc—possibly at least partially open—at a bottom end face of the filter medium. As an alternative or in addition thereto, the filter element may comprise an end disc—possibly at least partially open—at a top end face of the filter medium. The filter element may be flowed through radially from the exterior to the interior, or alternatively, from the interior to the exterior.

The latching finger and/or the latching member may engage from behind the upper end disc at least in sections. In this way, the configuration of the filter is simplified in regard to construction.

In an embodiment, the filter element serves for centering the handle and the handle latching action. The filter element may comprise means in order to guide the handle into the latching position, for example, stays or grooves which interact with grooves or stays at the handle.

The filter may be embodied in the form of a liquid filter. The liquid filter may be configured in the form of a fuel filter or an oil filter. The filter may be embodied in the form of a fuel filter with, for example multiple, water-separating action(s). Such a filter element may be sealed with an O-ring in relation to the filter housing so that the filter element is seated very fast in the filter housing but is still easily exchanged by means of the handle according to the invention.

A constructively simple configuration of the filter is present when the latching member is provided at the filter housing and/or the latching finger is provided at the handle.

In an embodiment of the invention, the actuation surface is formed at the latching finger. The actuation surface may be formed opposite a latching projection of the latching finger.

In an embodiment of the invention, the handle latching action comprises a plurality of latching fingers. The latching fingers may be arranged or embodied symmetrically, for example with axial symmetry, at the handle. The handle latching action comprises at least six latching fingers.

In order to simplify the manufacture of the filter, the latching fingers may be identically configured.

A plurality of latching members are provided at the filter housing and a plurality of actuation surfaces at the handle for at least indirectly moving the latching members.

In this context, in the mounted state of the filter with pushed-on handle, two latching fingers may be provided adjacent to a latching member, respectively, wherein the latching members are provided between two latching fingers, respectively.

The latching members may be connected to two displacement surfaces, respectively. The displacement surfaces are arranged or embodied at the latching members at the free ends of the latching members.

The displacement surfaces may be embodied symmetrically, wherein the actuation surfaces, when the handle has been pushed on, are arranged radially on two displacement surfaces.

The constructive configuration of the filter may be further simplified when the filter housing comprises a ring with the at least one latching member. The ring may comprise all latching members and for example all displacement surfaces. The ring may be embodied as one piece, for example of plastic material. The ring may be connected by a weld connection to at least one additional component of the filter housing.

The object according to the invention is finally solved by a method for disassembly of a filter as described herein with the following method steps:
a) pushing on the handle with latching of the handle at the filter element and releasing the filter element latching action; and
b) pulling out the filter element.

In the method step a), a latching finger, for example all latching fingers, may be connected to the filter element by pushing the handle onto the filter element and a latching member, for example all latching members, are released from the filter element.

### BRIEF DESCRIPTION OF DRAWINGS

Further features and advantages of the invention result from the following detailed description of embodiments of the invention, as well as with the aid of the Figures of the drawings which illustrate details according to the invention. The aforementioned and still to be explained features may be realized each individually alone or several in any expedient combinations in variants of the invention. The features illustrated in the drawing Figures are illustrated such that the features and advantages according to the invention are made clearly visible.

FIG. 1 shows a perspective view of a filter with a filter housing, a filter element arranged in the filter housing, and a handle for connection to the filter element, unlatching of the filter element in the filter housing, and removal of the filter element.

FIG. 2 shows the filter of FIG. 1 with the handle attached to the filter element, wherein the latching action of the filter element in the filter housing is released by attachment of the handle.

FIG. 3 shows the filter of FIG. 1 and FIG. 2 with the filter element removed from the filter housing.

FIG. 4 shows a perspective view of the handle according to FIGS. 1 to 3, wherein downwardly projecting latching fingers for gripping the filter element are seen in FIG. 4.

FIG. 5 shows a perspective view of a ring which is mounted in the filter housing according to FIGS. 1 to 3, wherein the ring comprises latching members for holding the filter element in the filter housing.

FIG. 6 shows a partially sectioned perspective view of the filter according to FIGS. 1 to 3, wherein the handle is not completely attached to the filter housing.

FIG. 7 shows a longitudinal section view of the filter of FIG. 2 showing that the engagement of the latching member at the filter element is released by attachment of the handle to the filter element.

### DETAILED DESCRIPTION

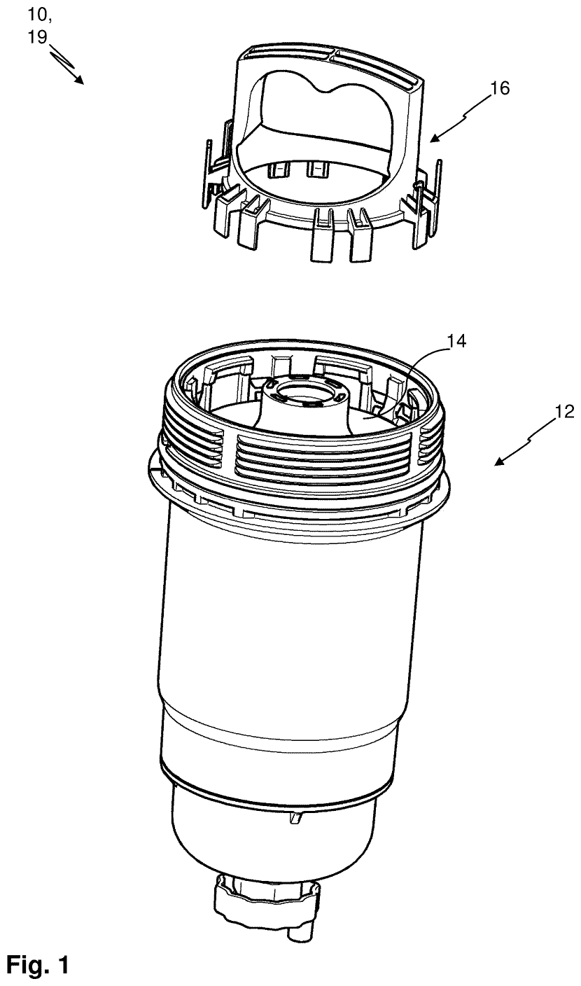

FIG. 1 shows a filter 10 with a filter housing 12, a filter element 14 installed in the filter housing 12, and a handle 16. The filter 10 is embodied in the form of a fuel filter.

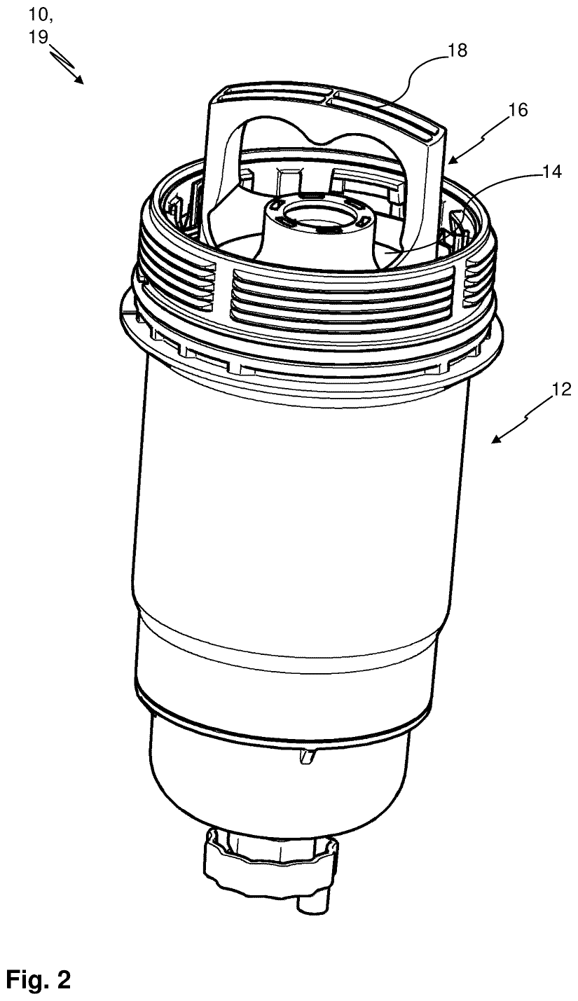

FIG. 2 shows the filter 10 with the handle 16 attached to the filter element 14. The handle 16 is latched at the filter element 14. By means of a handle grip 18, forces may be introduced into the filter element 14 in order to release it from its fixed seat in the filter housing 12.

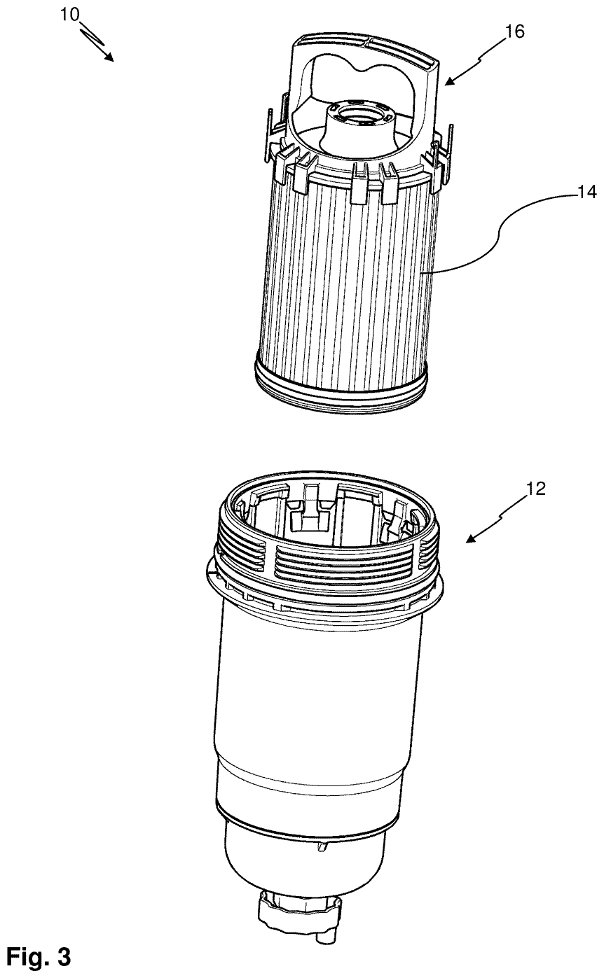

FIG. 3 shows the filter 10 with the filter element 14 pulled out of the filter housing 12, wherein the filter element 14 is connected still fixedly to the handle 16 so that the filter element 14 may be easily handled.

FIGS. 1 to 3 show a method 19 according to the invention for disassembly of the filter element 14 from the filter housing 12.

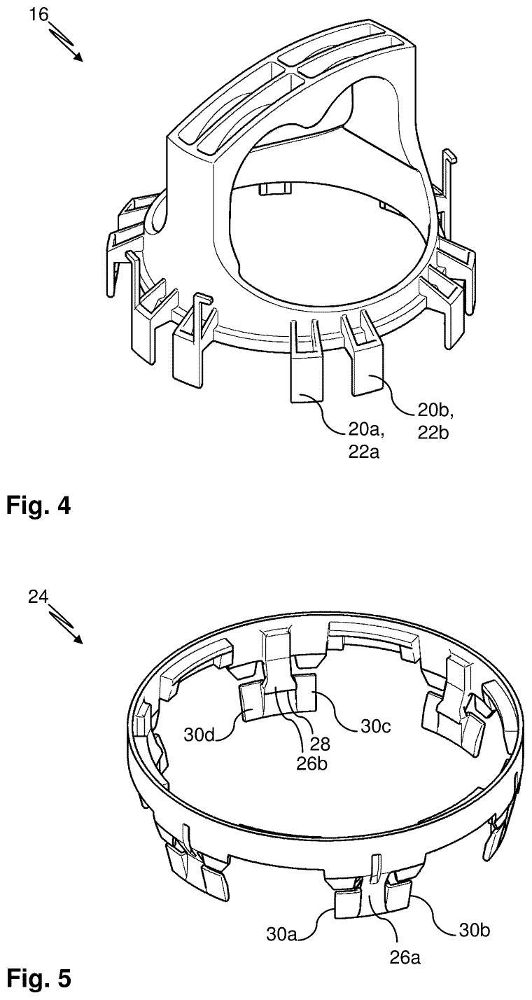

FIG. 4 shows the handle 16 with a plurality of latching fingers of which, for reasons of clarity, only the latching fingers 20a, 20b are provided with a reference character. The handle 16 may be configured as one piece (one part) and/or of plastic material. The latching fingers, here the latching fingers 20a, 20b, are arranged in pairs. A plurality of latching finger pairs (here six) are provided uniformly distributed at the handle 16.

The latching fingers 20a, 20b are axially embodied in sections. The latching fingers 20a, 20b may comprise, for example at their radially outer side, an actuation surface 22a, 22b, respectively. The actuation surfaces 22a, 22b serve for release of the latching action of the filter element 14 (see FIG. 2) in the filter housing 12 (see FIG. 2). This latching action becomes apparent in the context of FIG. 4 together with FIG. 5.

FIG. 5 shows a ring 24 fixedly arranged at the filter housing 12 (see FIG. 2) with a plurality of latching members of which, for reasons of clarity, only the latching members 26a, 26b are provided with a reference character. The latching members 26a, 26b serve for latching or axial securing of the filter element 14 (see FIG. 2) in the filter housing 12 (see FIG. 2). The latching members 26a, 26b comprise in this context a latching edge 28, respectively, which is seen in FIG. 5 at the latching member 26b. In its mounted state, the latching edge 28 engages at least partially the filter element 14.

The latching members 26a, 26b may be provided, for example centrally, between displacement surfaces, wherein in FIG. 5, for reasons of clarity, only the displacement surfaces 30a, 30b, 30c, 30d are provided with a reference character. The displacement surfaces 30a, 30b are provided at the radially inner side of the ring 24, which is hidden in FIG. 5. In general, the displacement surfaces 30a-d may be provided radially at the inner side. The displacement surfaces 30a-d coincide in their circumferential arrangement with the latching fingers 20a, 20b (see FIG. 4) so that the actuation surfaces 22a, 22b (see FIG. 4) displace the displacement surfaces 30a-d when the handle 16 is pushed on and move the latching members 26a, 26b, for example radially outwardly, so that the latching edges 28 no longer engage the filter element 14 (see FIG. 2).

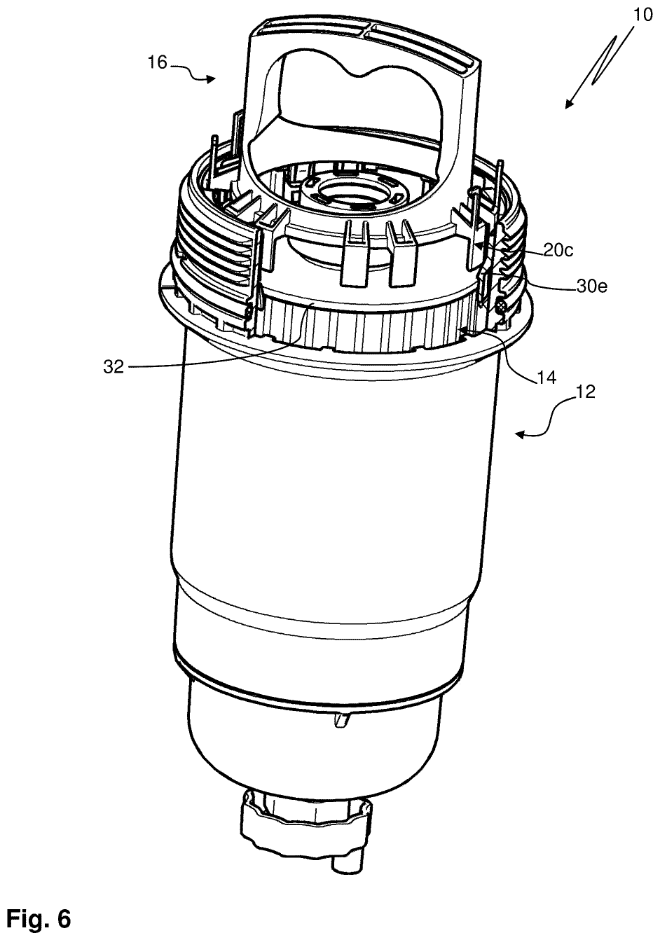

FIG. 6 shows the filter 10 with partially cut-away filter housing 12. The handle 16 is in a position shortly before engaging with its latching fingers a top end disc 32 of the filter element 14. For reasons of clarity, in FIG. 6 only one latching finger 20c is provided with a reference character. The latching finger 20c displaces in this context a displacement surface 30e in order to release a latching action of the filter housing 12 at the filter element 14.

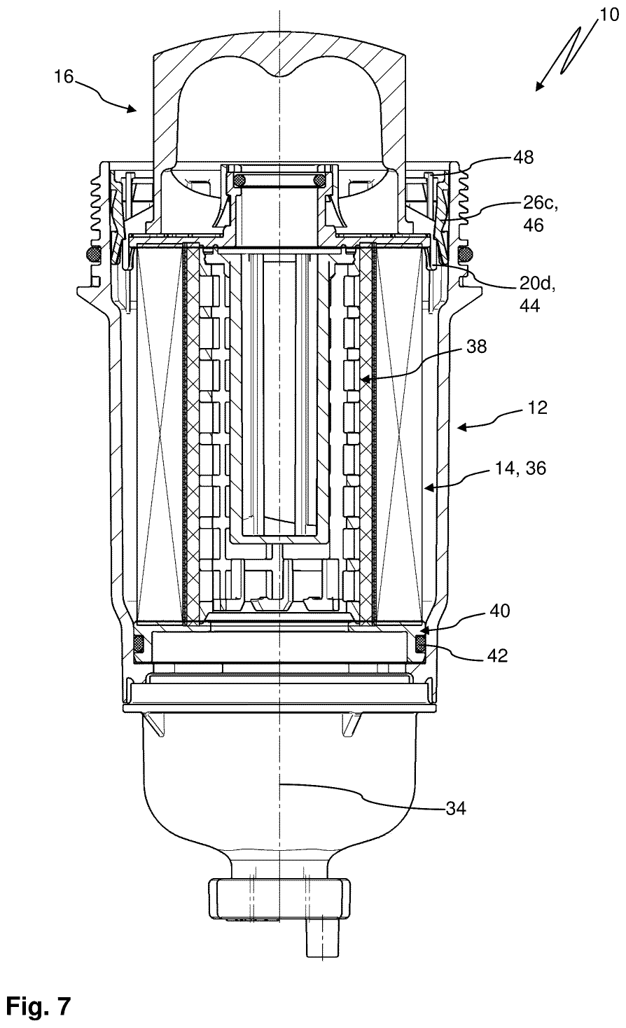

FIG. 7 shows a longitudinal section view of the filter 10. FIG. 7 shows that the filter element 14 is configured to have axial symmetry in relation to its longitudinal axis 34. It comprises a filter medium 36 which may be folded in a star shape and is supported radially inwardly at a support body 38. A bottom end disc 40 is sealed with a seal ring 42, here in form of an O-ring, in relation to the inner side of the filter housing 12. This seal seat is usually very strong so that the handle 16 must be used in order to pull the filter element 14 out of the filter housing 12.

FIG. 7 shows the filter element 14 with attached handle 16. Latching fingers, of which one latching finger 20d is provided with a reference character, unlatch latching members of which in FIG. 7 a latching member 26c is provided with a reference character. The connection of the latching finger 20d at the filter element 14 forms a handle latching action 44. The connection of the latching members 26c at the filter element 14 forms a filter element latching action 46.

At least one stop finger, of which in FIG. 7 one stop finger 48 is provided with a reference character, prevents that the handle 16, in case of already removed filter element 14, is pushed too deep into the filter housing 12, latches thereat, and then may be removed only in a complex manner.

By looking at all Figures of the drawings together, the invention in summary concerns a filter 10 with a filter housing 12, a filter element 14, and a handle 16. The filter housing 12 may comprise at least one latching member 26a-c in order to hold the filter element 14 axially in the filter housing 12. The latching member 26a-c is at least indirectly releasable by an actuation surface 22a, 22b of the latching finger 20a-d at the handle 16. The latching finger 20a-d latches the handle 16 at the filter element 14, for example the latching finger 20a-d engages from behind a top end disc 32 of the filter element 14. The handle 16 comprises a plurality of latching fingers 20a-d which upon axially pushing the handle 16 onto the filter element 14 engage the latter from behind in the region of the top end disc 32. The latching fingers 20a-d may be pushed with their actuation surfaces 22a, 22b in pairs against the displacement surfaces 30a-d in order to release latching members 26a-c, provided between the displacement surfaces 30a-e, from the filter element 14.

### LIST OF REFERENCE CHARACTERS

10 filter
12 filter housing
14 filter element
16 handle
18 handle grip
19 method
20a-d latching finger
22a, b actuation surface
24 ring
26a-c latching member
28 latching edge
30a-e displacement surface
32 top end disk
34 longitudinal axis of the filter element
36 filter medium
38 support body
40 bottom end disk
42 seal ring
44 handle latching action
46 filter element latching action
48 stop finger

What is claimed is:

1. A filter comprising:
an exchangeable filter element;
a filter housing configured to receive the filter element;
a filter element latching action provided between the filter housing and the filter element, wherein the filter element latching action holds the filter element in a mounted state in the filter housing so as to be secured against an axial pulling-out action, wherein the filter element latching action comprises one or more latching members which are radially movable at least in sections;
a handle configured to axially pull out the filter element from the filter housing;
a handle latching action provided between the handle and the filter element and configured to hold the filter element at the handle, wherein the handle latching action comprises one or more latching fingers which are radially moveable at least in sections; and
one or more actuation surfaces provided between the handle and the filter element, wherein the one or more actuation surfaces are configured to release the filter element latching action;
wherein, by pushing the handle onto the filter element, the handle latching action is lockable by the one or more latching fingers and the filter element latching action is releasable by the one or more actuation surfaces acting on the one or more latching members to at least partially radially move the one or more latching members.

2. The filter according to claim 1, wherein the filter is a liquid filter.

3. The filter according to claim 1, wherein the one or more latching members of the filter element latching action are provided at the filter housing and/or the one or more latching fingers of the handle latching action are provided at the handle.

4. The filter according to claim 1, wherein the one or more actuation surfaces are arranged at the one or more latching fingers.

5. The filter according to claim 1, wherein the one or more latching members of the filter element latching action are disposed at the filter housing, and wherein the one or more actuation surfaces are disposed at the handle.

6. The filter according to claim 5, wherein, in an attached state of the handle, two of the latching fingers are arranged adjacent to one of the latching members, respectively, so that the latching members are arranged between the latching fingers, respectively.

7. The filter according to claim 6, further comprising displacement surfaces arranged adjacent to the one or more latching members and movable by the one or more actuation surfaces when pushing the handle onto the filter element so as to release the filter element latching action, and wherein each one of the one or more latching members is connected to two of the displacement surfaces, respectively.

8. The filter according to claim 7, wherein the one or more latching members each are arranged between said two displacement surfaces which are symmetrical relative to each other.

9. The filter according to claim 1, wherein the filter housing comprises a ring comprising the one or more latching members.

10. A method for disassembly of the filter according to claim 1, the method comprising:
pushing the handle onto the filter element arranged in the filter housing, wherein the handle latches at the filter element so as to lock the handle latching action and wherein the one or more actuation surfaces release a latching action of the one or more latching members to release the filter element latching action; and
pulling out the filter element by the handle from the filter housing.

11. The method according to claim 10, further comprising:
providing the one or more latching members of the filter element latching action at the filter housing and/or providing the one or more latching fingers of the handle latching action at the handle; and
in the step of pushing the handle onto the filter element, the one or more latching fingers latching at the filter element and the one or more latching members being released from the filter element.

12. The filter element for the filter according to claim 1, the filter element comprising:
a filter medium surrounding in an annular shape a longitudinal axis;
wherein the filter element is configured to be latched by the one or more latching members in the filter housing of the filter;
wherein the filter element is configured to be at least partially engaged by a latching edge of the one or more latching members; and
wherein the filter element is configured to be engaged by the one or more latching fingers to form the handle latching action.

13. The filter element according to claim 12, wherein the filter element is configured to be axially secured by the one or more latching members.

14. The filter element according to claim 12, wherein the filter medium is folded in a star shape or is wound.

15. The filter element according to claim 12, wherein the filter element is round or oval.

16. The handle for removal of the filter element from the filter according to claim 1, wherein the handle is configured to be connected by the handle latching action comprising the one or more latching fingers to the filter element, and wherein the handle comprises the one or more actuation surfaces configured to release the filter element latching action.

17. The handle according to claim 16, wherein the handle comprises a handle grip configured to introduce forces into the filter element in order to release the filter element from the filter housing.
